(19) United States
(12) Patent Application Publication
(10) Pub. No.: US 2010/0066673 A1
(43) Pub. Date: Mar. 18, 2010

(54) Laser pointer capable of detecting a gesture associated therewith and representing the gesture with a function

(76) Inventor: Shang Tai Yeh, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/232,340

(22) Filed: Sep. 16, 2008

(51) Int. Cl. G06F 3/033

(52) U.S. Cl. 345/158

(57) ABSTRACT

Described is a laser pointer capable of detecting a gesture associated therewith and representing the gesture with a function, comprising a light emitting unit for emitting a laser light; a detection unit for detecting a set of accelerations composed of at least an acceleration of the gesture and outputting an acceleration signal set; a control unit for receiving and outputting the acceleration signal set or outputting a processed acceleration signal set; and a communications unit for receiving and transmitting the acceleration signal set or the processed acceleration signal set through a communications channel to be received by an electronic device in order to determine the gesture and perform the corresponding function according to the acceleration signal set or the processed acceleration signal set.

### BACKGROUND OF THE INVENTION

1. Field of Invention

The present invention relates to a laser pointer and particularly to a laser pointer capable of detecting a gesture associated therewith and representing the gesture with a function.

2. Description of the Related Art

A laser pointer is typically used in a presentation environment by a speaker. In the presentation, a speaker uses the laser pointer to spotlight a portion of his/her presentation content projected on a presentation screen. However, the currently used tool for the presentation can be limiting since the speaker has to concurrently manipulate a computer for providing, interacting, and adjusting the presentation content that is on display, for example the act of turning the page for the presentation content or moving a cursor among the presentation content, which can be inconvenient. Sometimes, in order to side step this limitation, the speaker may even have to arrange a person exclusively for manipulating the computer on the speaker's behalf. Accordingly, this way of operating presentation which requires multiple people can be inefficient and inconvenient for the speaker and the people involved.

If there is a way to more conveniently manipulate the laser pointer and the computer simultaneously, the speaker can adjust the timing and presentation style on the fly, backtrack to previous pages for in depth explanation and reference, or simply saving the hassle of requiring multiple people coordinating a presentation, all of these are advantages when compared to the case of using conventional presentation tool.

In view of the above discussion, there is a need to provide a laser pointer with which the presentation content projected from the computer can be controlled to be displayed as desired, so that the laser pointer can be simultaneously used to spotlight and control the presentation content in a presentation environment.

### SUMMARY OF THE INVENTION

It is, therefore, an object of the present invention to provide a laser pointer capable of detecting a gesture associated therewith and representing the gesture with a function, so as to overcome the limitation encountered in the prior art.

The laser pointer capable of detecting a gesture associated therewith and representing the gesture with a function that is in accordance with the present invention comprises a light emitting unit for emitting a laser light; a detection unit for detecting a set of accelerations composed of at least the acceleration of the gesture and for outputting an acceleration signal set; a control unit for receiving and outputting the acceleration signal set or for outputting a processed acceleration signal set; and a communications unit for receiving and transmitting the acceleration signal set or the processed acceleration signal set through a communications channel to be received by an electronic device in order to determine the gesture and perform the corresponding function according to the acceleration signal set or the processed acceleration signal set.

In one embodiment, a driver software storing a lookup table therein is installed in the electronic device, the lookup table is for describing a mapping relationship between a plurality of acceleration signal sets and a plurality of function signals, and is used for interpreting the received acceleration signal set into a corresponding function signal from using the plurality of function signals as the processed acceleration signal set.

In another embodiment, a lookup table for describing a mapping relationship between a plurality of acceleration signal sets and a plurality of function signals is stored in the control unit and is used for interpreting the received acceleration signal set into a corresponding function signal from using the plurality of function signals as the processed acceleration signal set, and the electronic device has a driver software therein for performing the function according to the function signal from the control unit.

In one embodiment, the function is one of the group consisting of scrolling to a next page, scrolling to a previous page, moving a cursor, turning on a light, and playing a sound.

In one embodiment, a key unit is provided which comprises at least a key (button) for receiving a command representing a function issued from a user through the key unit, which in turn producing a key signal according to the command and outputting the key signal to the control unit, and the control unit interprets the key signal into a command signal and transmits the command signal through the communications unit to be received by the electronic device to perform the command.

In one embodiment, the control unit receives the key signal from the key unit and acceleration signal set from the detection unit and outputs a hybrid signal of the two as the processed acceleration signal set according to acceleration signal set. In a further embodiment, the acceleration signal set or the hybrid signal set will indicate a corresponding function; wherein once an electronic device receives the acceleration signal set the corresponding function will be carried out. In order to avoid confusion, the term “function” will be further defined here as “a predefined function”, defined as a predefined operation or action to be carried out by electronic devices.

By means of the present invention, a user may benefit from convenience in cooperation with an electronic device such as a computer in a presentation environment.

### BRIEF DESCRIPTION OF THE DRAWINGS

Above and other objects of the present invention will become readily apparent by reference to the following detailed description when considered in conjunction with accompanying drawings wherein:

FIG. 1 is a schematic diagram of a presentation environment where a user uses a laser pointer to give a presentation in cooperation with a computer projecting a presentation content onto a presentation screen and the presentation content is marked by the laser pointer manipulated by the user;

FIG. 2 is a schematic diagram of a functional block diagram of a laser pointer capable of detecting a gesture associated therewith and representing the gesture with a function according to the present invention; and

FIG. 3A and FIG. 3B are first embodiment schematic diagrams of a lookup table stored in a driver software and a control unit of the laser pointer according to the present invention, respectively.

FIG. 4A and FIG. 4B are second embodiment schematic diagrams of a lookup table stored in a driver software and a control unit of the laser pointer according to the present invention, respectively.

### DETAILED DESCRIPTION OF THE INVENTION

The present invention is a laser pointer capable of detecting a gesture associated therewith and representing the gesture with a function. The laser pointer is used by a user in a presentation environment. The user can make a gesture by using the hand to grab the laser pointer which can be used to control an electronic device such as a computer that can project a presentation content onto a presentation screen and/or other electronic devices, so that the user can conveniently control the projected presentation content or events associated with the presentation environment. The present invention will be described by using preferred embodiments with reference to accompanying drawings.

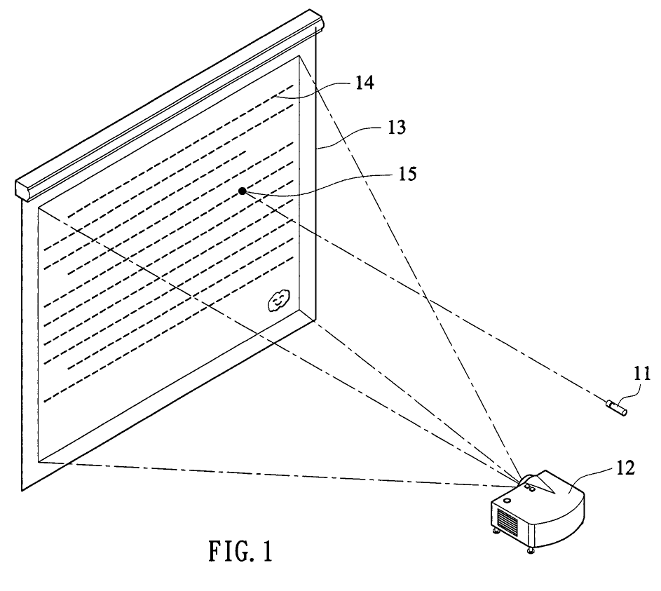

FIG. 1 is a schematic diagram of a presentation environment where a user uses a laser pointer to give a presentation in cooperation with a computer projecting a presentation content onto a presentation screen and the presentation content is marked by the laser pointer manipulated by the user. As shown in FIG. 1, numeral label 11 is the laser pointer, 12 is the electronic device, 13 is the presentation screen, 14 is a presentation content projected from the electronic device, and 15 is a marked point made by the laser pointer 11 on a spotlighted portion of the presentation content 14. The electronic device 12 may be a computer.

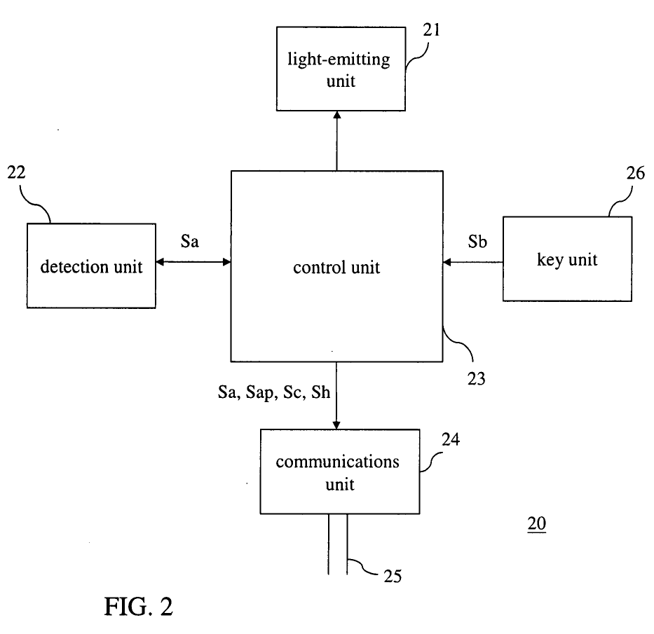

FIG. 2 is a schematic diagram of a functional block diagram of a laser pointer capable of detecting a gesture associated therewith and representing the gesture with a function according to the present invention. As shown in FIG. 2, the laser pointer 20 comprises a light-emitting unit 21, a detection unit 22, a control unit 23, and a communications unit 24.

The light-emitting unit 21 emits a laser light. The laser light may be emitted under control of the control unit 22 (the case shown in FIG. 2) or independently of the control unit 22. The laser light is provided to display a spotlighted portion of the presentation content 14 projected from the electronic device 12 when used in cooperation with the laser pointer 11, as described above.

The detection unit 22 is used to detect a hand gesture of the user while grabbing the laser pointer 21. In detecting the gesture, the detection unit 22 detects at least an acceleration of the user hand. The detection unit 22 comprises an acceleration sensor.

The “at least an acceleration” may constitute a set of accelerations. In response to the set of accelerations, the detection unit 22 outputs an acceleration signal set Sa according to the set of accelerations.

Next, the control unit 23 receives the acceleration signal set Sa and outputs directly the acceleration signal Sa or a processed acceleration signal Sap after the acceleration signal set Sa is processed.

Then, the communications unit 24 receives and transmits the acceleration signal set Sa or the processed acceleration signal set Sap through a communications channel 25. The mentioned processing on the acceleration signal set Sap will be described later. The communications unit 24 may be a wireless communications unit or a cabled communications unit. The wireless communications unit may be an infrared (IR) unit, a Bluetooth unit, or a radio frequency (RF) unit, or other communication unit that serve the same purpose of transceiving signals. The electronic device 12 may be a computer or an electronic device having a micro-control unit (not shown) for communications with the laser light and capable of executing the function and with a communications unit through which the micro-control unit can use to communicate with the laser light (not shown). The function performed through the laser (i.e. pointer 20) may include scrolling the presentation content to a next page, scrolling the presentation content to a previous page, moving a cursor among the presentation content, turning on a light, and playing a sound. Typically the electronic device 12 is a computer since a user generally makes a presentation in cooperation with a computer. However, the electronic device 12 may be devices other than a computer, such as a lamp or a speaker (not shown) as long as the lamp and speaker are equipped with the mentioned micro-control unit and communications unit. In this case, the lamp and speaker may be controlled to brighten or darken and make a sound in the presentation environment.

Accordingly, the user can make a spotlight on an aimed portion of the presentation content and manipulate the electronic device projecting the presentation content simultaneously by using the laser pointer in a presentation environment. Furthermore, the use of the laser pointer can even manipulate electronic devices other than the one used for projecting the presentation content, particularly the ones associated with the presentation. As such, a presentation gain greater control for the user and there is no need to have an extra person for exclusively manipulating the presentation electronic device.

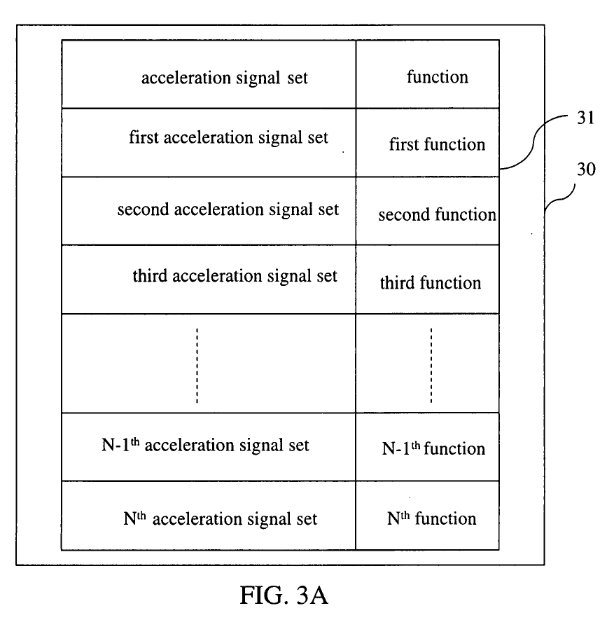

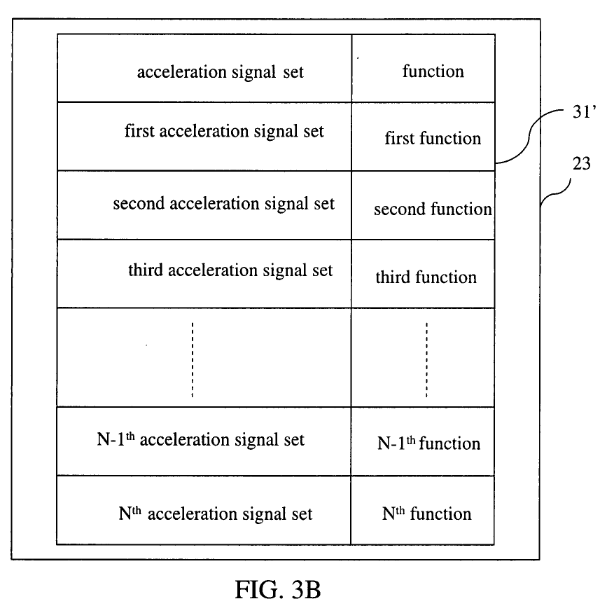

In an embodiment, the electronic device 12 is installed with a driver software 30 storing a lookup table 31 therein, shown in FIG. 3A. The lookup table 31 describes a mapping relationship between a plurality of acceleration signal sets and a plurality of function signals. By referring to the lookup table 31, the received acceleration signal set Sa may be interpreted into a particular function signal among the plurality of possible function signals; wherein the particular function signal is served as the above mentioned “processed acceleration signal set Sap”. At this time, the driver software 30 performs the function according to the function signal for the electronic device.

In an alternate embodiment, the control unit 23 comprises a lookup table shown in FIG. 3B. The lookup table 31′ describes a mapping relationship between a plurality of acceleration signal sets and a plurality of function signals. By referring to the lookup table 31′ for interpreting the received acceleration signal set Sa into a particular function signal from the plurality of possible function signals; wherein the particular function signal is served as the processed acceleration signal set Sap. At this time, the electronic device has a driver software therein for performing the function according to the function signal from the control unit 23.

In addition, the laser pointer 20 may further comprise a key unit 26 comprising at least a key(button) for receiving a command representing a function issued by the user. The key unit 26 also outputs a key signal Sb according to the command and outputs the key signal Sb to the control unit 23. Subsequently, the control unit 23 interprets the key signal Sb as a command signal Sc and transmits the command signal Sc through the communications unit 24 to the electronic device 12, so that the electronic device 12 can perform the function corresponding to the command according to the command signal Sc.

In an embodiment, the control unit 23 receives the key signal Sb from the key unit 26 and the acceleration signal set Sa from the detection unit 22. Then, the control unit 23 outputs the processed acceleration signal set Sap according to the key unit Sb and the acceleration signal set Sa. Namely, the signals Sb and Sa are combined as a hybrid signal Sh, through which the electronic device is controlled to perform the function. In an embodiment, the control unit 23 enables the detection unit 22 to detect if any acceleration is presented after the key signal Sb from the key unit 26 is received. In the present invention, if no key signal Sb is outputted from the key unit 26, a pure acceleration signal set Sa from the detection unit 22 is also termed as a hybrid signal Sh. In addition, the term “processed” in the “processed acceleration signal set Sap” may indicate one of or both the above processing of mapping (such as those associated with the lookup table 31, 31′) and combination of key and acceleration signal (such as those associated with the hybrid signal Sh).

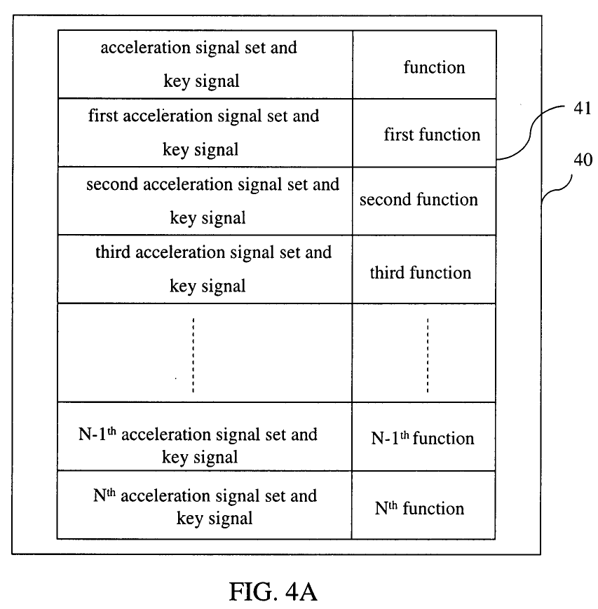

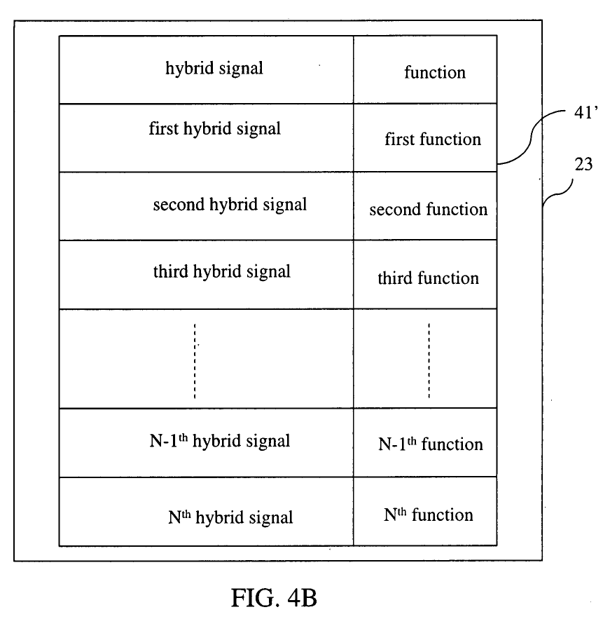

In this case, a driver software 40 having a lookup table 41, for storing a mapping relationship describing a plurality of hybrid signals and a plurality of functions (as shown in FIG. 4A), is installed in the electronic device 12. The control unit 23 transmits a function signal according to the received hybrid signal Sh by referring to the lookup table 41. At this time, the function signal is served as the above mentioned “processed acceleration signal set Sap”. In a different embodiment, the control unit 23 comprises a lookup table 41′ in which a mapping relationship describing a plurality of hybrid signals and a plurality of functions is stored (as shown in FIG. 4B). Based on the lookup table 41′, the control unit 23 interprets the received acceleration signal set Sa into a function signal; wherein the function signal is then served as the above mentioned “processed acceleration signal set signal Sap”.

In the above, the function represented by the command received by the key unit 26 may also be used for scrolling the presentation content to a next page, scrolling the presentation content to a previous page, moving a cursor among the presentation content, turning on a light, playing a sound, or other operation function purposes.

It is readily apparent that the above-described embodiments have advantage of wide commercial utility. It should be understood that the specific form of the invention herein and described above is intended for illustrative purpose only, as certain modifications within the scope of these teachings will be apparent to those skilled in the art. Accordingly, reference should be made to the following claims in determining the full scope of the invention.

What is claimed is:

1. A laser pointer capable of detecting a gesture associated therewith and representing the gesture with a function, comprising:
a light emitting unit for emitting a laser light;
a detection unit for detecting a set of accelerations composed of at least an acceleration of the gesture and outputting an acceleration signal set;
a control unit for receiving and outputting acceleration signal set or outputting a processed acceleration signal set; and
a communications unit for receiving and transmitting the acceleration signal set or the processed acceleration signal set through a communications channel to be received by an electronic device in order to determine the gesture and perform the corresponding function according to the acceleration signal set or the processed acceleration signal set.

2. The laser pointer as claimed in claim 1, wherein the detection unit is an acceleration sensor.

3. The laser pointer as claimed in claim 1, wherein a driver software storing a lookup table therein is installed in the electronic device, the lookup table is for describing a mapping relationship between a plurality of acceleration signal sets and a plurality of function signals, and is used for interpreting the received acceleration signal set into a corresponding function signal from using the plurality of function signals as the processed acceleration signal set.

4. The laser pointer as claimed in claim 1, wherein the control unit comprises a lookup table for describing a mapping relationship between a plurality of acceleration signal sets and a plurality of function signals, and is used for interpreting the received acceleration signal set into a corresponding function signal from using the plurality of function signals as the processed acceleration signal set, and the electronic device has a driver software therein for performing the function according to the function signal from the control unit.

5. The laser pointer as claimed in claim 1, wherein the communications unit is a wireless communications unit and includes an infrared (IR) unit, a Bluetooth unit, or a radio frequency (RF) unit.

6. The laser pointer as claimed in claim 1, wherein the communications unit is a cabled communications unit coupled to the electronic device through a cable.

7. The laser pointer as claimed in claim 1, wherein the electronic device is a computer or an electronic device having a micro-control unit for communications with the laser light and capable of executing the function and with a communications unit through which the micro-control unit can use to communicate with the laser light.

8. The laser pointer as claimed in claim 1, wherein the function is a predefined function.

9. The laser pointer as claimed in claim 8, wherein the function includes scrolling to a next page, scrolling to a previous page, moving a cursor, turning on a light, and playing a sound.

10. The laser pointer as claimed in claim 1, wherein the light-emitting unit is controlled to emit the laser light by the control unit.

11. The laser pointer as claimed in claim 1, further comprising:
a key unit comprising at least a key for receiving a command representing a function issued from a user through the key unit, which in turn producing a key signal according to the command and outputting the key signal to the control unit, and
the control unit interprets the key signal into a command signal and transmitting the command signal through the communications unit to be received by the electronic device to perform the command.

12. The laser pointer as claimed in claim 11, wherein the control unit receives the key signal from the key unit and the acceleration signal set from the detection unit and outputs a hybrid signal as the processed acceleration signal set according to the acceleration signal set.

13. The laser pointer as claimed in claim 12, wherein the control unit controls the detection unit to detect the set of accelerations to output the processed acceleration signal set after receiving the key signal.

14. The laser pointer as claimed in claim 12, wherein a driver software storing a lookup table therein is installed in the electronic device, the lookup table is for describing a mapping relationship between a plurality of hybrid signals and a plurality of function signals, and is used for interpreting the received hybrid signal into a corresponding function signal from using the plurality of function signals as the processed acceleration signal set.

15. The laser pointer as claimed in claim 12, wherein the control unit comprises a lookup table for describing a mapping relationship between a plurality of hybrid signals and a plurality of function signals, and is used for interpreting the received hybrid signal into a function signal from using the plurality of function signals as the processed acceleration signal set, and the electronic device has a driver software therein for performing the function according to the function signal from the control unit.

16. The laser pointer as claimed in claim 11, wherein the function is a predefined function.

17. The laser pointer as claimed in claim 16, wherein the function includes scrolling to a next page, scrolling to a previous page, moving a cursor, turning on a light, and playing a sound.
